(19) United States
(12) Patent Application Publication
(10) Pub. No.: US 2011/0058594 A1
(43) Pub. Date: Mar. 10, 2011

(54) COMMUNICATION METHOD AND POWER LINE COMMUNICATION TERMINAL

(75) Inventors: Takayoshi KOYAMA, Kyoto (JP); Yuichi Yamamoto, Kyoto (JP); Hitoshi Tahara, Osaka (JP); Nobutaka Kodama, Fukuoka (JP)

(73) Assignee: Panasonic Corporation, Osaka (JP)

(21) Appl. No.: 12/879,580

(22) Filed: Sep. 10, 2010

Related U.S. Application Data
(63) Continuation of application No. PCT/JP2008/003741, filed on Dec. 12, 2008.

(30) Foreign Application Priority Data
May 16, 2008 (JP) 2008-129444

(51) Int. Cl. H04B 3/00; H04B 1/38

(52) U.S. Cl. 375/222; 375/257

(57) ABSTRACT

In power line communication using a power line as a transmission path, a transmitter terminal transmits a communication signal while changing a phase parameter of the communication signal transmitted, in the continuous communication signal, according to an impedance variation amount on the transmission path. In this communication method, the communication signal is received stably with no variation in the phase parameter of the communication signal in response to the impedance variation amount on the transmission path, permitting high-speed data communication with reduced communication error.

### CROSS-REFERENCE TO RELATED APPLICATION

This is a continuation of PCT International Application PCT/JP2008/003741 filed on Dec. 12, 2008, which claims priority to Japanese Patent Application No. 2008-129444 filed on May 16, 2008. The disclosures of these applications including the specifications, the drawings, and the claims are hereby incorporated by reference in their entirety.

### BACKGROUND

The present disclosure relates to a communication method adopting a multicarrier transmission scheme, and more particularly to a communication method and communication device adopting a multicarrier transmission scheme in power line communication using power lines as a communication medium.

In power line communication devices using power lines as a communication medium, high-speed data transfer can be achieved by adopting a multicarrier transmission scheme using orthogonal frequency division multiplexing (OFDM). In the multicarrier transmission scheme, conventionally, fast Fourier transform (FFT) based OFDM and wavelet-based OFDM are often used.

FIG. 7 shows a conceptual configuration of a power line communication device using wavelet-based OFDM. In a transmitter device 100, a symbol mapper 110 converts transmission data received from a higher-order layer to symbol data, to perform symbol mapping according to the symbol data. For the resultant symbol map, a phase rotator 120 performs phase rotation of degrees varying with sub-carriers for reduction of the peek to average power ratio (PAPR). A serial-to-parallel (S/P) converter 130 assigns a real value di (i=1 to M) to each of the sub-carriers, and an inverse wavelet transformer 140 performs inverse wavelet transform on to the time axis. In this way, sample values having a time-axis waveform are generated, to produce a sample value sequence representing transmission symbols. A D/A converter 150 converts the sample value sequence to a temporally continuous baseband analog signal waveform, and transmits the resultant signal. In a receiver device 200, an A/D converter 210 converts a reception signal to a digital signal, and a wavelet transformer 220 performs wavelet transform to allow handling of phase information. A parallel-to-serial (P/S) converter 230 converts the resultant data to series data, and a phase rotator 240 changes the phases of the sub-carriers rotated for PAPR reduction to their original phases. A carrier detector 250 detects presence/absence of the reception signal, a synchronous circuit 260 extracts synchronizing timing from the reception signal, and an equalizer 270 corrects the reception signal to cancel an influence of a transmission path. A determiner 280 determines the reception signal using a threshold.

In power line communication using power lines as a communication medium, noise fluctuates severely during communication because a number of other household electric appliances are connected to the communication path. Therefore, with only extraction of synchronizing timing and equalization of a transmission path characteristic using preamble symbols 510 and synchronization symbols 520 generally added to the head of a communication signal as shown in FIG. 8, for example, if the transmission path characteristic changes due to an influence of noise during reception of a continuous communication signal, reception of a post-noise portion of information symbols 530 will become difficult. The preamble symbols 510 may be pilot symbols and the like in which all carriers are sine-wave signals, for example. The receiver device 200, receiving such a signal, estimates the characteristics of the amplitude and phase of each carrier and adjusts reception parameters, thereby performing equalization of the transmission path characteristic (compensation of the transmission characteristic, etc.).

In particular, change in transmission path characteristic due to impedance variations raises a serious problem in high-speed communication. It is known that there is an appliance that changes the impedance characteristic of a transmission path periodically in synchronization with the cycle of the A/C power supply (one cycle or a half cycle). If a power line to which such an appliance is connected is used as a transmission path, the amplitude and phase characteristics of the transmission path will change every several milliseconds, greatly increasing the error rate of the communication signal. Therefore, if an application in which the latency of the communication path is important, such as Voice over Internet protocol (VoIP), and an application in which large-volume communication high in real-time constraints is necessary, such as stream distribution of high definition (HD) images, are transmitted in power line communication, the increase in the error rate of the communication signal will appear as phenomena such as dropouts and image disturbances.

To address the above problem, considered is a communication device that is provided with a circuit of detecting the voltage phase of the AC power supply and the error rate, to acquire data indicating the correlation between the voltage phase and the error rate, and halts communication at a voltage phase whose corresponding error rate is equal to or more than a threshold (see Japanese Patent Publication No. 2000-124841 (p. 5, FIG. 2, etc.), for example).

Also considered is a communication device that equalizes the transmission path characteristic periodically by inserting a pilot symbol among information symbols a plurality of times or in synchronization with the cycle of the AC power supply (see Japanese Patent Publication No. 2006-186734, for example).

### SUMMARY

In the communication method in which communication is halted at a voltage phase whose corresponding error rate is equal to or more than a threshold, communication error due to impedance variations can be reduced. However, this method inevitably reduces the communication speed.

In the communication method in which a pilot symbol is inserted among information symbols, since the pilot symbol itself does not contribute to actual data communication, the band use efficiency decreases. Also, if the impedance variation position in the voltage phase is deviated from the pilot symbol insertion position, error data communication will continue from the impedance variation position until the next pilot symbol insertion position.

In view of the above circumstances, it is an objective of the present invention to provide a communication method and device capable of suppressing decrease in communication speed irrespective of occurrence of impedance variations on a transmission path in power line communication adopting a multicarrier transmission scheme.

The communication method of the present invention is characterized in that, in power line communication using a power line as a transmission path, a transmitter terminal transmits a communication signal while changing a phase parameter of the communication signal transmitted, in the continuous communication signal, according to an impedance variation amount on the transmission path.

In the above communication method, the communication signal is received stably with no variation in the phase parameter of the communication signal in response to the impedance variation amount on the transmission path. Therefore, high-speed data communication with reduced communication error can be achieved.

In the communication method described above, the impedance variation amount on the transmission path may be estimated by a receiver terminal receiving a transmission path state estimation signal transmitted by the transmitter terminal and analyzing the transmission path state estimation signal.

In the above communication method, it is possible to make use of a signal whose nature (level, phase, etc.) is known and thus which is suitable for estimation of the impedance variation amount on the transmission path. Therefore, the impedance variation amount on the transmission path can be estimated precisely.

In the communication method described above, the impedance variation amount on the transmission path may be estimated by a receiver terminal receiving a normal data communication signal transmitted by the transmitter terminal and analyzing the normal data communication signal.

In the above communication method, the impedance variation amount on the transmission path can be estimated with no need of a communication band for transmission of a special signal.

In the communication method described above, the transmission path state estimation signal or the normal data communication signal may be transmitted by the transmitter terminal in a form receivable by all terminals in a network.

In the above communication method, in a network having a number of communication terminals, the impedance variation amount on the transmission path between the transmitter terminal and each of the other terminals can be estimated efficiently.

In the communication method described above, the impedance variation amount on the transmission path may be generated as a variation amount map using one cycle of AC power flowing through the power line as a unit.

In the above communication method, the phase parameter of the transmission signal can be changed appropriately in response to impedance variations generated every cycle of the AC power supply.

In the communication method described above, the impedance variation amount on the transmission path may be generated as a variation amount map using 1/N (N is an integer) of the cycle of AC power flowing through the power line as a unit. In the above communication method, the phase parameter of the transmission signal can be changed appropriately in response to impedance variations generated every 1/N cycle of the AC power supply.

In the communication method described above, the impedance variation amount on the transmission path may be generated as a variation amount map using N times (N is an integer) of the cycle of AC power flowing through the power line as a unit.

In the above communication method, the phase parameter of the transmission signal can be changed appropriately in response to impedance variations generated every N-fold cycle of the AC power supply.

In the communication method described above, the impedance variation amount on the transmission path may be acquired in advance of first normal data communication from the transmitter terminal to the receiver terminal.

In the above communication method, communication can be started with an optimum phase parameter at the time of data communication.

In the communication method described above, the impedance variation amount on the transmission path may be acquired/updated sequentially every time the transmitter terminal performs normal data communication.

In the above communication method, it is possible to perform communication while correcting the phase parameter to an appropriate value sequentially with no overhead at the start of data communication. It is also possible to perform communication sequentially following a dynamically varying impedance variation amount on the transmission path.

In the communication method described above, the impedance variation amount on the transmission path may be updated periodically.

In the above communication method, it is possible to perform communication periodically following a dynamically varying impedance variation amount on the transmission path irrespective of the transmission status from the transmitter terminal.

In the communication method described above, the impedance variation amount on the transmission path estimated by the receiver terminal may be sent to the transmitter terminal as a dedicated communication signal indicating a transmission path state estimation result.

In the above communication method, the impedance variation amount on the transmission path can be sent to the transmitter terminal speedily irrespective of the transmission status from the transmitter terminal.

In the communication method described above, the impedance variation amount on the transmission path estimated by the receiver terminal may be sent together with an acknowledgment signal sent from the receiver terminal to the transmitter terminal in response to communication from the transmitter terminal to the receiver terminal.

In the above communication method, the impedance variation amount on the transmission path can be sent to the transmitter terminal with no need of a communication band for transmission of a special signal.

In the communication method described above, in the processing of changing the phase parameter of the communication signal transmitted, the transmitter terminal may insert a communication signal other than the normal data communication during the time of impedance variations on the transmission path.

In the above communication method, communication error during abrupt impedance variations, which is observed until the impedance variation amount on the transmission path is stabilized, can be reduced compared with the case of performing normal data communication during this time.

In the communication method described above, the communication signal other than the normal data communication may be a pilot symbol from which the receiver terminal estimates an influence of impedance variations of the communication signal, and the receiver terminal may correct a phase parameter of a reception signal based on the pilot symbol.

In the above communication method, high-speed communication with further reduced communication error during the time of impedance variations can be achieved.

In the communication method described above, in the processing of changing the phase parameter of the communication signal transmitted, the transmitter terminal may also change an amplitude parameter of the communication signal.

In the above communication method, high-speed communication with reduced communication error can be achieved even when the amplitude also greatly changes due to impedance variations on the transmission path.

The power line communication terminal of the present invention is a power line communication terminal using a power line as a transmission path, including: means of acquiring information related to an impedance variation amount on the transmission path; and means of transmitting a communication signal while changing a phase parameter, or both the phase parameter and an amplitude parameter, of the communication signal transmitted, in the continuous communication signal, according to the acquired information.

Alternatively, the power line communication terminal of the present invention is a power line communication terminal using a power line as a transmission path, including: means of receiving a transmission path state estimation signal or a normal data communication signal; and means of estimating an impedance variation amount on the transmission path by analyzing the received signal.

The power line communication terminal described above may further include means of switching between enabling and disabling the processing of changing the phase parameter or the processing of changing both the phase parameter and the amplitude parameter under user operation.

The power line communication terminal described above may further include means of displaying a state of enabling/disabling the processing of changing the phase parameter or the processing of changing both the phase parameter and the amplitude parameter.

According to the present invention, in power line communication adopting a multicarrier transmission scheme, communication capable of suppressing decrease in communication speed even when impedance variations occur on the transmission path can be achieved.

Also, with no need to insert a signal that does not contribute to actual data communication, communication can be performed without degrading the band use efficiency.

### BRIEF DESCRIPTION OF THE DRAWINGS

FIG. 1 is a block diagram showing a schematic configuration of a power line communication system of the first embodiment.

FIG. 2 is a view schematically illustrating a transmission signal in the first embodiment.

FIG. 3 is a block diagram showing a schematic configuration of a transmitter device of the second embodiment.

FIG. 4 is a view schematically illustrating a transmission signal in the second embodiment.

FIG. 5 is a schematic illustration of part of a communication frame in the fourth embodiment.

FIG. 6 is a view schematically illustrating a transmission signal and the communication frame in the fourth embodiment.

FIG. 7 is a block diagram showing a conceptual configuration of a power line communication device using wavelet-based OFDM as a multicarrier transmission scheme.

FIG. 8 is a schematic illustration of part of a communication frame in a multicarrier transmission scheme.

### DETAILED DESCRIPTION

Embodiments of the present invention will be described hereinafter with reference to the accompanying drawings. Note that components denoted by the same reference character throughout the embodiments operate similarly, and thus repetitive description of such components is omitted in some cases.

### First Embodiment

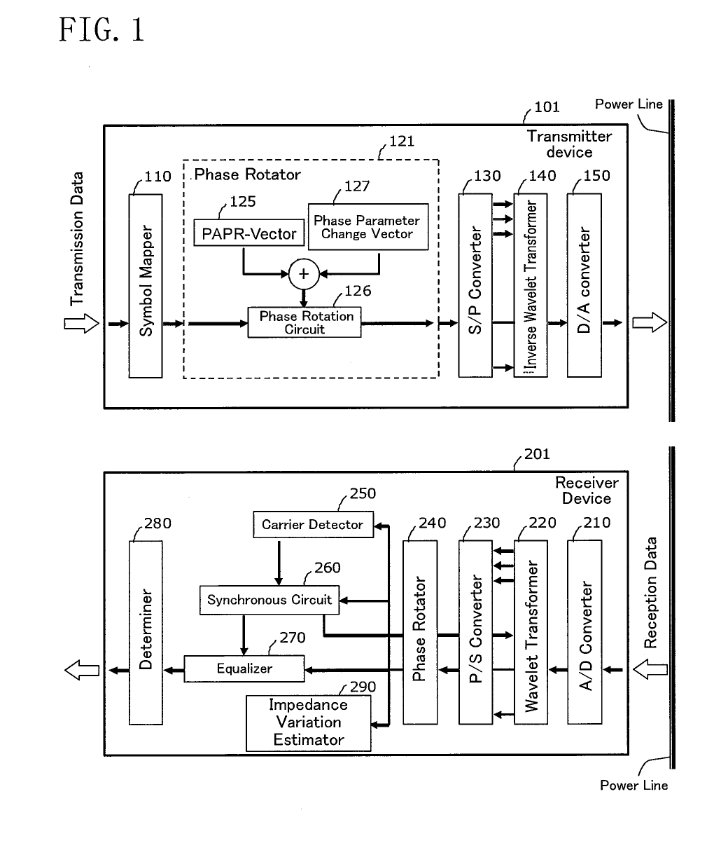

FIG. 1 is a block diagram showing a schematic configuration of a power line communication system of the first embodiment. This communication system performs communication between a transmitter device 101 and a receiver device 201 under a multicarrier transmission scheme. Note that, in this embodiment, wavelet-based OFDM is used as the multicarrier transmission scheme as an example.

Referring to FIG. 1, the transmitter device 101 includes: a symbol mapper 110 that performs symbol-mapping of a bit sequence as transmission data; a phase rotator 121 that performs phase rotation of the symbol-mapped data; a serial-to-parallel (S/P) converter 130 that performs serial-to-parallel conversion of the phase-rotated data; an inverse wavelet transformer 140 that performs inverse wavelet transform of the resultant real values on to the time axis, to generate a sample value sequence having a time-axis waveform; and a D/A converter 150 that converts the sample value sequence to an analog signal waveform. The receiver device 201 includes: an A/D converter 210 that converts the received analog signal to a digital signal, a wavelet transformer 220 that performs wavelet transform of the digital signal, to generate an in-phase signal and an orthogonal signal; a parallel-to-serial (P/S) converter 230 that converts the wavelet-transformed reception data to series data; a phase rotator 240 that performs phase rotation of the resultant data; a carrier detector 250 that detects the transmission signal transmitted from the transmitter device 101; a synchronous circuit 260 that secures synchronization with the reception signal; an equalizer 270 that corrects the reception signal distorted due to the transmission path characteristic; a determiner 280 that performs determination using a signal output from the equalizer 270; and an impedance variation estimator 290 that analyzes/estimates the impedance variation amount on the transmission path.

The phase rotator 121 includes: a PAPR-vector 125 for rotating the phase of each sub-carrier for reduction of PAPR; a phase parameter change vector 127 set based on the impedance variation amount on the transmission path; and a phase rotation circuit 126 that rotates the phase of a signal. While the PAPR-vector 125 is one-dimensional information holding a phase rotation parameter for each sub-carrier, the phase parameter change vector 127 is two-dimensional information holding a phase rotation parameter for each sub-carrier and for each arbitrary unit time.

The operation of the transmitter device 101 and the receiver device 201 configured as described above will be described in relation to communication therebetween.

When the transmitter device 101 is in its initial startup and when no impedance variation exists on the transmission path between the transmitter device 101 and the receiver device 201, all of the parameters in the phase parameter change vector 127 are set to zero. In normal date communication performed from the transmitter device 101 to the receiver device 201 in this state, data subjected to symbol mapping by the symbol mapper 110 is phase-rotated by the phase rotation circuit 126 using only the PAPR-vector 125, and the resultant data is passed to the next S/P converter 130.

In addition to the normal data communication described above, the transmitter device 101 also transmits a transmission path state estimation signal to the receiver device 201. The transmission path state estimation signal may be made of pilot symbols and the like in which all carriers are sine-wave signals, for example. In the receiver device 201 having received the transmission path state estimation signal, the impedance variation estimator 290 estimates the impedance variation amount on the transmission path as a transition on the time axis during reception of the signal. The receiver device 201 sends the estimated impedance variation amount to the transmitter device 101 as a signal representing the transmission path state estimation result.

The transmitter device 101 accumulates information on the phase characteristic, out of the impedance variation amount sent from the receiver device 201, in the phase parameter change vector 127. In the phase parameter change vector 127, data is constructed on the time axis as a change amount transition map in a cycle N times or 1/N times the power cycle (N is an integer), for example, in one power cycle. As a way of accumulation, sequential overwrite with new data, arithmetic mean, and the like may be adopted.

When normal data communication from the transmitter device 101 to the receiver device 201 is performed in the state of the phase parameter change vector 127 having data constructed by the processing described above, data subjected to symbol mapping by the symbol mapper 110 is phase-rotated by the phase rotation circuit 126 using a value obtained by combining the PAPR-vector 125 and a phase parameter given from the phase parameter change vector 127 acquired in correspondence with the power cycle, and then passed to the next S/P converter 130.

The processing in the S/P converter 130 and the subsequent components of the transmitter device 101 and the processing in the receiver device 201 are the same as those during the initial startup when all of the parameters in the phase parameter change vector 127 are set to zero.

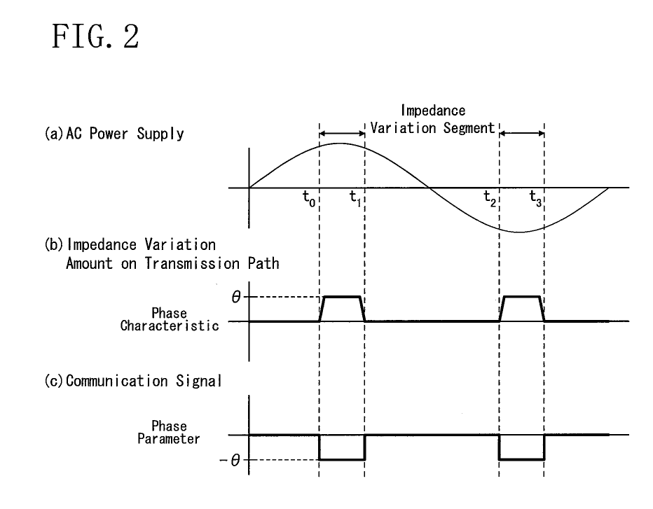

FIG. 2 schematically shows a communication signal transmitted from the transmitter device 101. Assume the case that as the impedance variation amount on the transmission path, the phase characteristic changes by θ as shown in FIG. 2(b) during time segments t0 to t1 and t2 to t3 as offset times from zero cross points of one power cycle shown in FIG. 2(a). In this case, as shown in FIG. 2(c), the phase parameter of the communication signal is changed by −θ during the time segments t0 to t1 and t2 to t3.

In this embodiment, the following effect can be obtained.

In the phase rotator 121 of the transmitter device 101, the phase parameter is changed in advance in a temporally continuous transmission signal based on the impedance variation amount on the transmission path between the transmitter device 101 and the receiver device 201. With this change, the phase parameter of the signal received by the receiver device 201 is kept constant. Therefore, communication error due to impedance variations on the transmission path can be reduced, permitting high-speed communication.

Although this embodiment was described as adopting wavelet-based OFDM as the multicarrier transmission scheme, other modulation schemes (e.g., FFT-based OFDM) may be adopted.

When the transmitter device 101 does not have a phase rotator using a PAPR-vector, only the phase parameter change vector 127 and the phase rotation circuit 126 may be additionally provided.

When there are a number of terminals with which the transmitter device 101 communicates, the phase parameter change vector 127 may further have individual information for each of such terminals, constructing three-dimensional information.

In a network having a plurality of terminals, the transmission path state estimation signal may be transmitted in a form receivable by all the terminals (broadcasted), and all the terminals having received the signal may estimate simultaneously the impedance variation amounts of the transmission paths between the transmitter devices 101 and the respective terminals.

The impedance variation amount estimated by the impedance variation estimator 290 may include only the variation amount related to the phase characteristic.

The signal representing the transmission path state estimation result sent from the receiver device 201 may include only the variation amount related to the phase characteristic in the impedance variation amount.

The transmitter device 101 may transmit the transmission path estimation signal periodically, so that estimation of the impedance variation amount on the transmission path and updating of the phase parameter change vector 127 can be executed periodically.

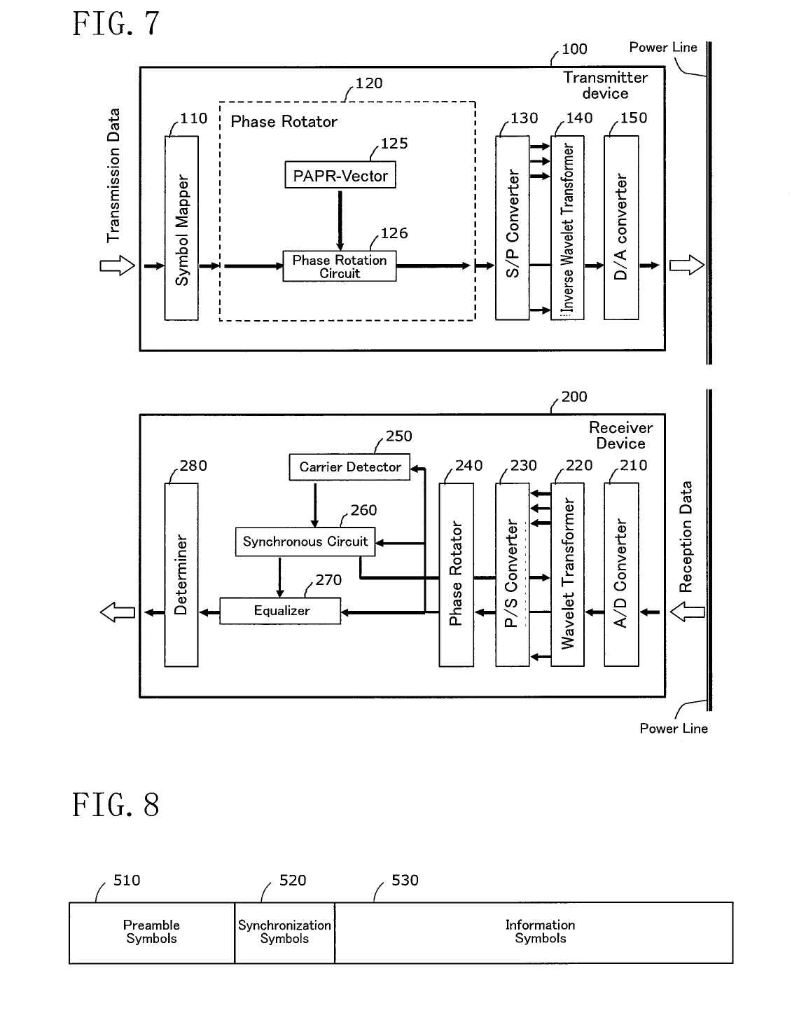

The transmitter device 101 may have the estimator 290 for estimating the impedance variation amount on the transmission path. In this case, with no special component required for the receiver device 201, the conventional receiver device 200 shown in FIG. 7 can be used as it is.

### Second Embodiment

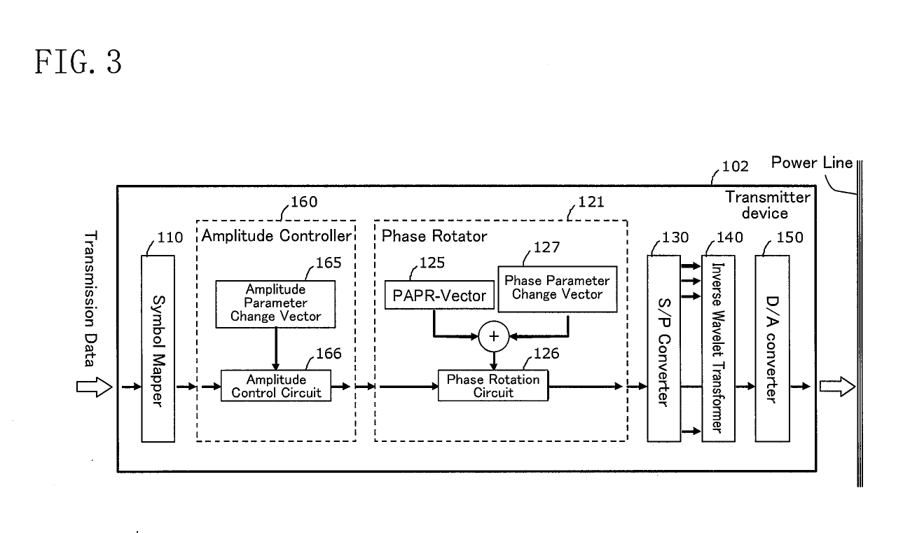

A power line communication system of the second embodiment performs communication between a transmitter device 102 shown in FIG. 3 and the receiver device 201 shown in FIG. 1 under a multicarrier transmission scheme using power lines as a communication medium. In FIG. 3, the same components as those in FIG. 1 are denoted by the same reference characters. Note that, in this embodiment, wavelet-based OFDM is used as the multicarrier transmission scheme as an example.

A configuration unique to the transmitter device 102 in this embodiment is an amplitude controller 160. Amplitude control of the transmission signal can be carried out by the symbol mapper 110 of the transmitter device 101 in the first embodiment shown in FIG. 1. In this case, normally, only the amplitude value of each sub-carrier is determined according to a predetermined transmission level map. On the contrary, in the transmitter device 102 shown in FIG. 3, amplitude control is carried out based on an amplitude parameter change vector 165 that holds an amplitude parameter for each sub-carrier and for each arbitrary unit time.

The operation of the transmitter device 102 and the receiver device 201 configured as described above will be described in relation to communication therebetween.

The processing up to the acquirement of the impedance variation amount on the transmission path from the receiver device 201 is the same as that in the first embodiment. The transmitter device 102 constructs the amplitude parameter change vector 165, simultaneously with the construction of the phase parameter change vector 127, from the information on the impedance variation amount received from the receiver device 201. When the phase parameter change vector 127 is constructed as a change amount transition map in a half of the power cycle, for example, the amplitude parameter change vector 165 is also constructed as a change amount transition map in a half of the power cycle.

When normal data communication from the transmitter device 102 to the receiver device 201 is performed in the state of the phase parameter change vector 127 and the amplitude parameter change vector 165 having data constructed by the processing described above, data subjected to symbol mapping by the symbol mapper 110 is first amplitude-controlled by an amplitude control circuit 166 using an amplitude parameter given from the amplitude parameter change vector 165 acquired in correspondence with the power cycle. The data is then phase-rotated by the phase rotation circuit 126 using a value obtained by combining the PAPR-vector 125 and a phase parameter given from the phase parameter change vector 127 acquired in correspondence with the power cycle. The resultant data is passed to the next S/P converter 130.

The processing in the S/P converter 130 and the subsequent components of the transmitter device 102 and the processing in the receiver device 201 are the same as those described in the first embodiment.

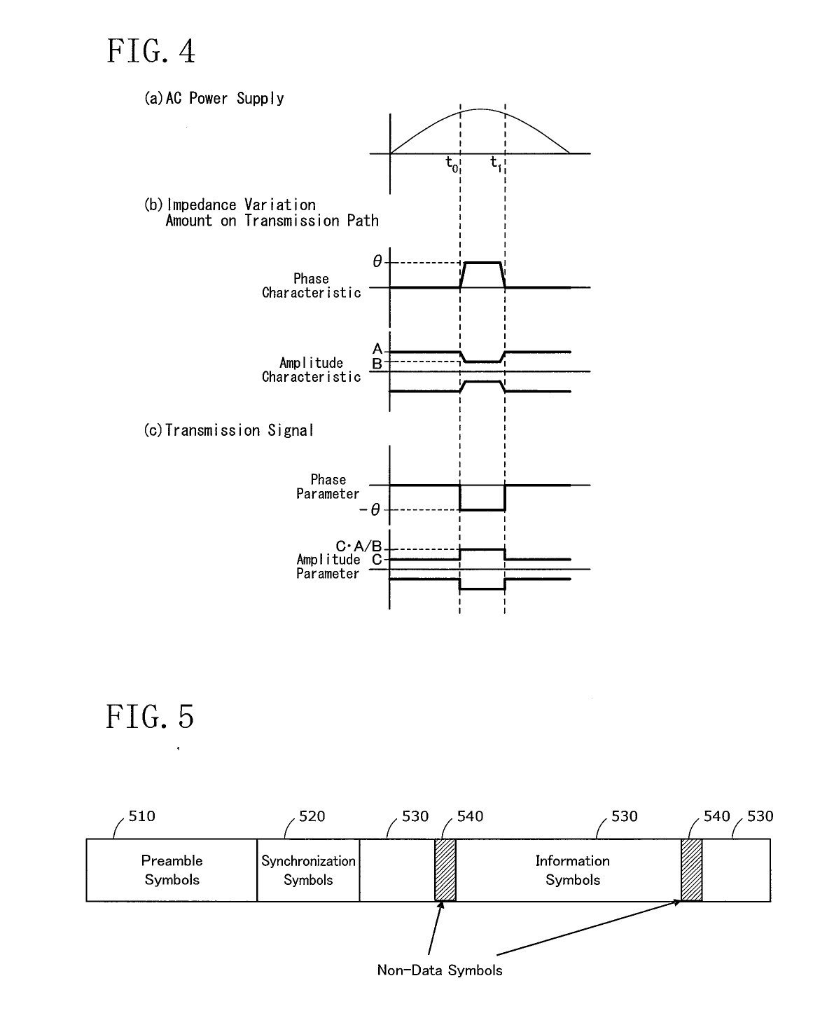

FIG. 4 schematically shows a communication signal transmitted from the transmitter device 102. Assume the case that, as the impedance variation amount on the transmission path, the phase characteristic changes by θ and the amplitude characteristic changes from A to B as shown in FIG. 4(b) during time segment t0 to t1 as an offset time from a zero cross point of a half power cycle shown in FIG. 4(a). In this case, as shown in FIG. 4(c), the phase parameter of the transmission signal is changed by −θ and the amplitude parameter thereof is changed by C·A/B with respect to the reference value C (C is an arbitrary value) during the time segment t0 to t1.

In comparison with the first embodiment, an effect unique to this embodiment is as follows.

In the amplitude controller 160 of the transmitter device 102, the amplitude parameter is changed in advance in a temporally continuous transmission signal based on the impedance variation amount on the transmission path between the transmitter device 102 and the receiver device 201, together with the change of the phase parameter. With this change, the amplitude parameter and phase parameter of the signal received by the receiver device 201 is kept constant. Therefore, communication error due to impedance variations on the transmission path can be further reduced.

Although both the phase parameter change vector 127 and the amplitude parameter change vector 165 are constructed in a half of the power cycle in this embodiment, they may be constructed in their individual cycles.

### Third Embodiment

The third embodiment is different from the first and second embodiments in that no transmission path state estimation signal is transmitted for estimation of the impedance variation amount on the transmission path between the transmitter device 101 (or the transmitter device 102; hereinafter represented by the transmitter device 101) and the receiver device 201.

In this embodiment, the impedance variation amount on the transmission path is estimated using communication of normal data transmitted from the transmitter device 101 to the receiver device 201. More specifically, using the preamble symbols 510 added to the head of the communication signal as shown in FIG. 8 in normal data communication, the receiver device 201 estimates the impedance variation amount during the time of reception of the symbols. The preamble symbols are symbols in which all carriers are sine waves, for example. The impedance variation estimator 290 of the receiver device 201 estimates the impedance variation amount on the transmission path as a transition on the time axis during reception of the signal. The receiver device 201 sends the estimated result to the transmitter device 101 together with a signal indicating success of data reception (acknowledgment), for example.

In comparison with the first and second embodiments, an effect unique to this embodiment is as follows.

Since a communication band for transmitting a special signal for estimation of the impedance variation amount on the transmission path between the transmitter device 101 and the receiver device 201 is unnecessary, overhead of normal data communication can be eliminated.

In this embodiment, the impedance variation amount on the transmission path estimated in the receiver device 201 was sent to the transmitter device 101 under an acknowledgment signal. Alternatively, it may be sent to the transmitter device 101 as a signal representing the transmission path state estimation result.

### Fourth Embodiment

FIG. 5 is a view schematically showing part of a communication frame used when a communication method of the fourth embodiment is adopted.

As shown in FIG. 5, a configuration unique to this embodiment is insertion of non-data symbols 540 among the information symbols 530. The non-data symbols 540 are symbols irrelevant to transmission data given to the transmitter device from its higher-order layer. Such symbols are inserted at positions where the impedance abruptly varies.

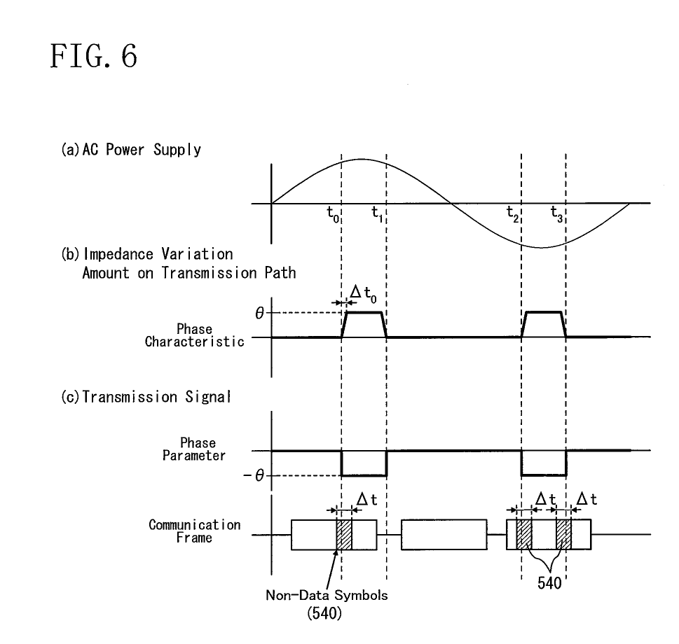

FIG. 6 schematically shows a communication signal obtained when the configuration of this embodiment is added to the structure of the first embodiment. Assume the case that, as the impedance variation amount on the transmission path, the phase characteristic changes by θ as shown in FIG. 6(b) during time segments t0 to t1 and t2 to t3 as offset times from zero cross points in one power cycle shown in FIG. 6(a). In this case, as shown in FIG. 6(c), the phase parameter of the transmission signal is changed by −θ during the time segments t0 to t1 and t2 to t3. Moreover, when transmission is performed striding positions where the impedance abruptly varies (t0, t1, t3), the non-data symbols 540 are inserted during time Δt including portions prior to and subsequent to the positions.

The time Δt is set to be equal to or more than the time period Δtθ during which the impedance is varying and include Δtθ. The time period Δtθ during which the impedance is varying refers to the time required until either or both of the phase change dθ and the amplitude change dA during a given time unit dt become equal to or less than their given thresholds.

In comparison with the first to third embodiments, an effect unique to this embodiment is as follows.

By inserting a signal irrelevant to transmission data (the non-data symbols 540) during the time period when the impedance on the transmission path varies abruptly, it is possible to reduce occurrence of communication error in segments in which any change in phase parameter or in both phase parameter and amplitude parameter symbol by symbol is of no use in avoiding error.

The non-data symbols 540 may be the transmission path state estimation signal. In this case, in addition to the effect of reducing communication error during the time period when the impedance on the transmission path varies abruptly, the impedance variation amount during this time period can be estimated further precisely.

### Fifth Embodiment

A power line communication system of the fifth embodiment will be described. A transmitter device of the power line communication system of this embodiment has a means of switching between function enabling and disabling, in addition to the components of the transmitter device 102 described in the second embodiment. The switching means may be a DIP switch provided outside the transmitter device 102, or may be setting in software installed in the device, for example. Other means may also be used.

When the function is disabled by the switching means described above, the transmitter device 102 transmits the communication signal without performing the processing of changing both the phase parameter and amplitude parameter of the communication signal.

In this embodiment, the following effect can be obtained.

The function may be disabled in circumstances having a limitation that the amplitude of the communication signal should be kept constant, for example, and enabled in the other circumstances. This facilitates construction of a power line communication system responding appropriately to such a limitation and the like.

The transmitter device in this embodiment may have a means of displaying the function enabling/disabling state set by the means described above. The displaying means may be an LED provided outside the transmitter device, or may be access to software installed in the device via a tool, for example. Other means may also be used.

The present invention is not limited to the embodiments described above, but various modifications are possible. It is without mentioning that such modifications should also be included in the scope of the invention.

The present invention has an effect that, in power line communication methods adopting a multicarrier transmission scheme, decrease in communication speed can be suppressed irrespective of occurrence of impedance variations on the transmission line, and therefore is useful in a power line communication device adopting a multicarrier transmission scheme for high-speed communication. In particular, the present invention is useful in power line communication methods and power line communication devices supposed to have applications in which the latency of the communication path is important, such as VoIP, and applications in which large-volume communication high in real-time constraints is necessary, such as stream distribution of HD images.

What is claimed is:

1. A communication method comprising:
in power line communication using a power line as a transmission path,
transmitting a communication signal by a transmitter terminal while changing a phase parameter of the communication signal transmitted, in the continuous communication signal, according to an impedance variation amount on the transmission path.

2. The communication method of claim 1, wherein
the impedance variation amount on the transmission path is estimated by a receiver terminal receiving a transmission path state estimation signal transmitted by the transmitter terminal and analyzing the transmission path state estimation signal.

3. The communication method of claim 1, wherein
the impedance variation amount on the transmission path is estimated by a receiver terminal receiving a normal data communication signal transmitted by the transmitter terminal and analyzing the normal data communication signal.

4. The communication method of claim 2, wherein
the transmission path state estimation signal is transmitted by the transmitter terminal in a form receivable by all terminals in a network.

5. The communication method of claim 1, wherein
the impedance variation amount on the transmission path is generated as a variation amount map using one cycle of AC power flowing through the power line as a unit.

6. The communication method of claim 1, wherein
the impedance variation amount on the transmission path is generated as a variation amount map using 1/N (N is an integer) of the cycle of AC power flowing through the power line as a unit.

7. The communication method of claim 1, wherein
the impedance variation amount on the transmission path is generated as a variation amount map using N times (N is an integer) of the cycle of AC power flowing through the power line as a unit.

8. The communication method of claim 1, wherein
the impedance variation amount on the transmission path is acquired in advance of first normal data communication from the transmitter terminal to a receiver terminal.

9. The communication method of claim 1, wherein
the impedance variation amount on the transmission path is acquired/updated sequentially every time the transmitter terminal performs normal data communication.

10. The communication method of claim 1, wherein
the impedance variation amount on the transmission path is updated periodically.

11. The communication method of claim 1, wherein
the impedance variation amount on the transmission path estimated by a receiver terminal is sent to the transmitter terminal as a dedicated communication signal indicating a transmission path state estimation result.

12. The communication method of claim 1, wherein
the impedance variation amount on the transmission path estimated by a receiver terminal is sent together with an acknowledgment signal sent from the receiver terminal to the transmitter terminal in response to communication from the transmitter terminal to the receiver terminal.

13. The communication method of claim 1, wherein
in the processing of changing the phase parameter of the communication signal transmitted, the transmitter terminal inserts a communication signal other than the normal data communication during the time of impedance variations on the transmission path.

14. The communication method of claim 13, wherein
the communication signal other than the normal data communication is a pilot symbol from which the receiver terminal estimates an influence of impedance variations of the communication signal, and
the receiver terminal corrects a phase parameter of a reception signal based on the pilot symbol.

15. The communication method of claim 1, wherein
in the processing of changing the phase parameter of the communication signal transmitted, the transmitter terminal also changes an amplitude parameter of the communication signal.

16. A power line communication terminal using a power line as a transmission path, comprising:
means of acquiring information related to an impedance variation amount on the transmission path; and
means of transmitting a communication signal while changing a phase parameter, or both the phase parameter and an amplitude parameter, of the communication signal transmitted, in the continuous communication signal, according to the acquired information.

17. A power line communication terminal using a power line as a transmission path, comprising:
means of receiving a transmission path state estimation signal or a normal data communication signal; and
means of estimating an impedance variation amount on the transmission path by analyzing the received signal.

18. The power line communication terminal of claim 16, further comprising:
means of switching between enabling and disabling the processing of changing the phase parameter or the processing of changing both the phase parameter and the amplitude parameter under user operation.

19. The power line communication terminal of claim 16, further comprising:
means of displaying a state of enabling/disabling the processing of changing the phase parameter or the processing of changing both the phase parameter and the amplitude parameter.
